(19) United States
(12) Patent Application Publication
(10) Pub. No.: US 2012/0188100 A1
(43) Pub. Date: Jul. 26, 2012

(54) TERMINAL, APPARATUS AND METHOD FOR PROVIDING CUSTOMIZED AUTO-VALET PARKING SERVICE

(75) Inventors: Kyoung-Wook MIN, Daejeon (KR); Jeong-Dan Choi, Daejeon (KR); Kyoung-Hwan An, Daejeon (KR); Kyung-Bok Sung, Daejeon (KR)

(73) Assignee: Electronics and Telecommunications Research Institute, Daejeon (KR)

(21) Appl. No.: 13/335,002

(22) Filed: Dec. 22, 2011

(30) Foreign Application Priority Data
Jan. 25, 2011 (KR) 10-2011-0007402

(51) Int. Cl. G08G 1/14

(52) U.S. Cl. 340/932.2

(57) ABSTRACT

The present invention provides a terminal, apparatus and method for providing a customized auto-valet parking service. The server device includes a service registration management unit for receiving auto-valet parking profile information that includes information about one or more of a user, a vehicle, and a mobile terminal, and a parking map management unit for generating customized parking slots suitable for the user using the auto-valet parking profile information, and providing a parking area map, which includes information about the customized parking slots, to the mobile terminal. The parking map management unit receives information about a final slot selected by the user from among the customized parking slots via the mobile terminal, and provides a route to the final slot.

### CROSS REFERENCE TO RELATED APPLICATION

This application claims the benefit of Korean Patent Application No. 10-2011-0007402, filed on Jan. 25, 2011, which is hereby incorporated by reference in its entirety into this application.

### BACKGROUND OF THE INVENTION

1. Technical Field

The present invention relates generally to a terminal, apparatus and method for providing a customized auto-valet parking service and, more particularly, to an apparatus and method for providing a user-customized auto-valet parking service in consideration of profile information received via the mobile terminal of a user.

2. Description of the Related Art

Auto-Valet Parking (AVP) is a service including both autonomous driving that drives a vehicle to a final slot within a parking lot in an unmanned manner, and autonomous parking that enables the vehicle to be parked in the final slot in an unmanned manner.

Providing such an AVP service is accompanied by the inconvenience of a driver having to install a separate terminal for the AVP service in the vehicle or to receive information from external infra sensors.

Therefore, a technology for providing the AVP service without installing a separate device in a vehicle is required.

### SUMMARY OF THE INVENTION

Accordingly, the present invention has been made keeping in mind the above problems occurring in the prior art, and an object of the present invention is to provide an apparatus and method for providing a user-customized AVP service using the mobile terminal of a user without having to install a separate device in a vehicle.

In accordance with an aspect of the present invention to accomplish the above object, there is provided a server device, including a service registration management unit for receiving Auto-Valet Parking (AVP) profile information that includes information about one or more of a user, a vehicle, and a mobile terminal; and a parking map management unit for generating customized parking slots suitable for the user using the auto-valet parking profile information, and providing a parking area map, which includes information about the customized parking slots, to the mobile terminal, wherein the parking map management unit receives information about a final slot selected by the user from among the customized parking slots via the mobile terminal, and provides a route to the final slot.

Preferably, the auto-valet parking profile information may include user profile information including information related to the user; mobile device profile information including information related to the mobile terminal; and vehicle profile information including information related to the vehicle.

Preferably, the user profile information may include a handicapped/non-handicapped person indication field for indicating whether the user is a handicapped person, a gender indication field for indicating a gender of the user, and an age indication field for indicating an age of the user.

Preferably, the mobile device profile information may include a Central Processing Unit (CPU) indication field for indicating a CPU of the mobile terminal, a resolution field for indicting resolution, and a communication method field for indicating a network.

Preferably, the vehicle profile information may include a vehicle license plate number field for indicating information about the vehicle, a vehicle model field for indicating a vehicle model, an electric/non-electric vehicle indication field for indicating whether the vehicle is an electric vehicle, and a vehicle size field for indicating a size of the vehicle.

Preferably, the parking area map may include AVP service area information including information about a parking space; parking route information including a route to the parking space; and slot information including information about all slots in the parking space.

Preferably, the slot information may include a slot outline indicated in a form of a line or a polygon defining the parking space; a parking slot for indicating information about each space in which a vehicle can be actually parked; a parking direction for indicating a direction in which the vehicle of the user enters when being parked; an available parking slot for indicating a possibility that the vehicle can be parked in an area except for an area invaded by a vehicle parked in a parking slot that is adjacent to the parking slot; and a slot type for indicting information about individual types of shapes in which the parking slots are formed.

Preferably, the parking map management unit may calculate an available parking slot among slots adjacent to the final slot based on image information captured by a camera installed in the vehicle once parking of the vehicle of the user in the final slot has been completed.

Preferably, the server device, may further include a monitoring management unit for performing monitoring while the vehicle of the user is performing autonomous driving and autonomous parking along the route to the final slot, then providing real-time vehicle monitoring information.

In accordance with another aspect of the present invention to accomplish the above object, there is provided a mobile terminal, including a profile information management unit for transferring Auto-Valet Parking (AVP) profile information, which includes information about one or more of a user, a vehicle, and a mobile terminal, to a server device and requesting registration on a customized auto-valet parking service from the server device; a parking map processing unit for performing control such that it receives a parking area map, which includes information about customized parking slots suitable for the user, from the server device and displays the parking area map; and a final slot information provision unit for transferring information about a final slot to the server device if the user determines the final slot from among the customized parking slots, wherein the final slot information provision unit receives information about a route to the final slot, generated by the server device using the information about the final slot, and requests the vehicle of the user to move along the route to the final slot and to be autonomously parked in the final slot.

Preferably, the mobile terminal may further include a monitoring information reception unit for receiving from the server device, information about real-time vehicle monitoring performed while the vehicle is performing autonomous driving and autonomous parking along the route to the final slot.

Preferably, the auto-valet parking profile information may include user profile information including information related to the user; mobile device profile information including information related to the mobile terminal; and vehicle profile information including information related to the vehicle.

Preferably, the parking area map may include AVP service area information including information about a parking space; parking route information including a route to the parking space; and slot information including information about all slots in the parking space.

In accordance with a further aspect of the present invention to accomplish the above object, there is provided a method of providing a customized auto-valet parking service, including receiving auto-valet parking profile information, which includes information about one or more of a user, a vehicle, and a mobile terminal, via the mobile terminal of the user; transferring a parking area map, which includes customized parking slots that are generated using the auto-valet parking profile information and are suitable for the user, to the mobile terminal; receiving information about a final slot, determined by the user from among the customized parking slots, from the mobile terminal; and generating a route to the final slot so that the vehicle can be autonomously parked, and transferring the route to the mobile terminal.

Preferably, the method may further include, once parking of the vehicle in the final slot has been completed, capturing image information about neighboring slots adjacent to the final slot using a camera installed in the vehicle; and generating information about an available parking slot among the neighboring slots, based on the image information.

Preferably, the method may further include transferring identification allocation information including identification to the mobile terminal if the user is registered on the customized auto-valet parking service.

According to embodiments of the present invention, an auto-valet parking service can be more conveniently provided in consideration of the conditions of a user by providing parking slots in a user-customized manner because customized parking slots are provided in consideration of user profile information, mobile device profile information, and vehicle profile information, unlike a conventional scheme for searching for and providing the locations of only empty slots.

Further, according to the embodiments of the present invention, a user personally selects a desired final slot from among customized parking slots via a mobile terminal, receives a screen on which a route to the selected final slot is displayed, and monitors the screen in real time, thus allowing the user to be provided with the auto-valet parking service in real time without having to install a separate device on a vehicle.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically showing a system for providing a customized auto-valet parking service according to an embodiment of the present invention.

FIGS. 2 to 4 are diagrams showing examples of an active auto-valet parking service.

FIG. 5 is a diagram schematically showing the server device of FIG. 1.

FIG. 6 is a diagram schematically showing auto-valet parking profile information according to an embodiment of the present invention.

FIG. 7 is a diagram schematically showing a parking area map according to an embodiment of the present invention.

FIGS. 8 to 12 are diagrams schematically showing the slot information of the parking area map shown in FIG. 5.

FIG. 13 is a diagram showing an example in which a route to a final slot is generated according to an embodiment of the present invention.

FIG. 14 is a diagram showing an example of a route to a final slot according to an embodiment of the present invention.

FIG. 15 is a diagram showing an example in which real-time vehicle monitoring information is provided according to an embodiment of the present invention.

FIG. 16 is a diagram showing an example in which parking completion state information is provided according to an embodiment of the present invention.

FIGS. 17 and 18 are diagrams showing an example in which parked state information and an available parking slot are generated according to an embodiment of the present invention.

FIG. 19 is a flowchart showing the flow of a process in which the server device of FIG. 5 provides a customized auto-valet parking service.

FIG. 20 is a diagram schematically showing the mobile terminal of FIG. 1.

FIG. 21 is a flowchart showing the flow of a process in which the mobile terminal of FIG. 20 provides a customized auto-valet parking service.

FIG. 22 is a diagram showing an example of the autonomous exit of a vehicle according to an embodiment of the present invention.

### DESCRIPTION OF THE PREFERRED EMBODIMENTS

The present invention will be described in detail below with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those having ordinary knowledge in the art to which the present invention pertains. Accordingly, in the drawings, the shapes and sizes of elements may be exaggerated for the sake of a clearer description.

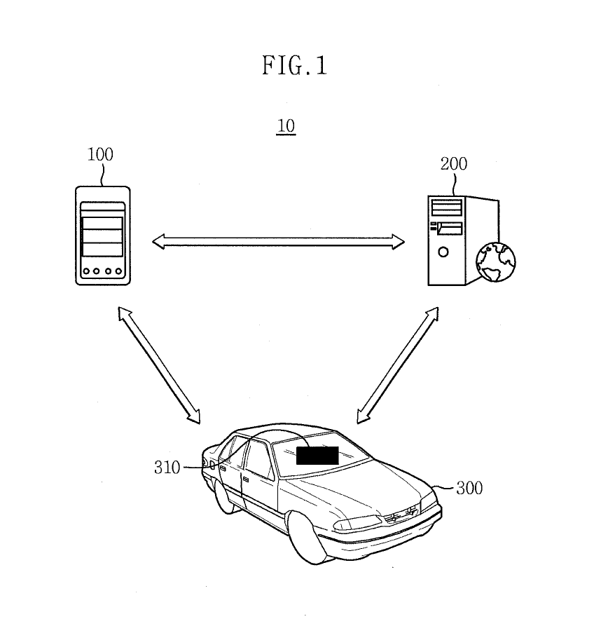

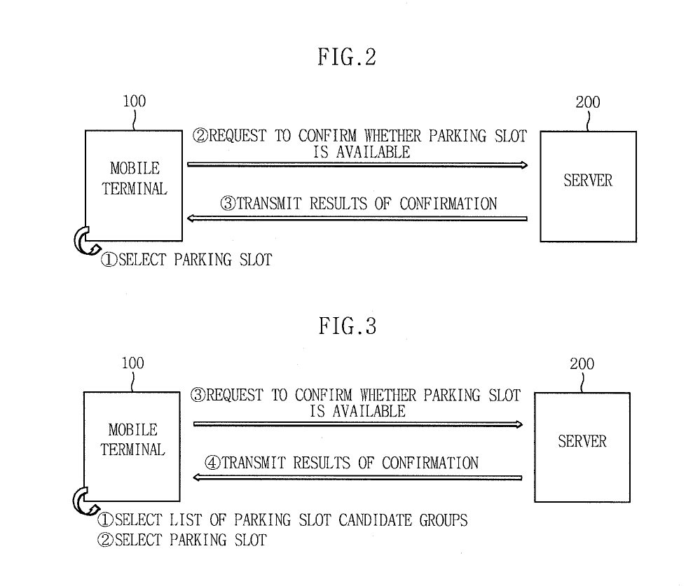

FIG. 1 is a diagram schematically showing a system for providing a customized auto-valet parking service according to an embodiment of the present invention. FIGS. 2 to 4 are diagrams showing examples of an active auto-valet parking service.

As shown in FIG. 1, a user-customized Auto-Valet Parking (AVP) system 10 for providing a user-customized auto-valet parking service (hereinafter referred to as a “customized auto-valet parking service”) according to an embodiment of the present invention includes an AVP mobile terminal (hereinafter referred to as a “mobile terminal”) 100, an AVP server device (hereinafter referred to as a “server device”) 200, and an AVP vehicle (hereinafter referred to as a “vehicle”) 300.

The mobile terminal 100 is the terminal of a user riding in a vehicle 300 and may be a mobile device such as a smart phone, an embedded device, or a mobile phone. The mobile terminal 100 downloads an algorithm for providing the customized auto-valet parking service, operates in conjunction with the server device 200 via the algorithm, and provides the status of the progress of the customized auto-valet parking service to the user in real time by displaying the status of the progress. The mobile terminal 100 according to an embodiment of the present invention may basically be a mobile terminal capable of providing the customized auto-valet parking service.

The server device 200 recognizes auto-valet parking information (such as the position, shape and heading of a vehicle, the location and shape of an obstacle, etc.) required to provide the customized auto-valet parking service using infra sensors, such as an image camera and a laser scanner, and provides the recognized information to the vehicle 300. Further, the server device 200 manages a parking area map, and provides the parking area map to the user when the user is registered on the customized auto-valet parking service. The server device 200 generates a route to the location of a final slot ultimately selected by the user and transfers the route to the vehicle 300.

The vehicle 300 includes a vehicle controller 310 for controlling unmanned driving. The vehicle controller 310 receives the route to the location of the final slot from the server device 200, and then controls the vehicle 300 so that the vehicle 300 can move to the final slot in an unmanned manner. When a fixed or movable obstacle is present, the vehicle controller 310 detects and avoids the obstacle, or temporarily stops and starts the vehicle. The embodiment of the present invention describes the vehicle controller 310 of the vehicle 300 as detecting the obstacle, but the present invention is not limited to this embodiment, and it is possible for the server device 200 to detect an obstacle and provide information about the obstacle to the vehicle controller 310.

As an example of a customized auto-valet parking service performed by the user-customized auto-valet parking system 10, the user of the vehicle 300 gets out of a vehicle at the entrance of an apartment complex, and then requests the customized auto-valet parking service from the server device 200 and the vehicle 300 via the mobile terminal 100. The server device 200 provides a parking area map to the mobile terminal 100. The mobile terminal 100 determines a final parking slot, in which the vehicle is to be parked, using the parking area map, and transmits information about the determined final parking slot to the server device 200. Then, the server device 200 generates a route to the final parking slot using the information about the final parking slot, and provides the route both to the mobile terminal 100 and to the vehicle 300. The vehicle controller 310 of the vehicle 300 performs autonomous driving up to the nearby area of the final parking slot within a parking lot, and thereafter performs autonomous parking. Further, the vehicle controller 310 or the server device 200 provides the results of the customized auto-valet parking service to the user in real time.

The customized auto-valet parking service according to the embodiment of the present invention may be provided in the form of an active auto-valet parking service that allows the mobile terminal 100 to select a slot and notify the server device 200 of the slot, or a passive auto-valet parking service that allows a final slot to be selected from among customized parking slots, which are generated using auto-valet parking profile information inputted by the user. Such auto-valet parking profile information will be described in detail later.

First, in an example of the active auto-valet parking service, as shown in FIG. 2, when the user selects a parking slot using the mobile terminal 100 (\textcircled{1}) and then requests confirmation of the parking slot from the server device 200 (\textcircled{2}), the server device 200 transmits the results of confirmation, indicating whether the selected parking slot is available, to the user via the mobile terminal 100 (\textcircled{3}).

In another example of the active auto-valet parking service, as shown in FIG. 3, when the mobile terminal 100 selects a list of candidate groups for parking slots and selects a parking slot (\textcircled{1}, \textcircled{2}) and then requests confirmation of the parking slot from the server device 200 (\textcircled{3}), the server device 200 transmits the results of confirmation, indicating whether the parking slot is available, to the user via the mobile terminal 100 (\textcircled{4}).

In a further example of the active auto-valet parking service, as shown in FIG. 4, the mobile terminal 100 requests a candidate group for parking slots from the server device 200 (\textcircled{1}). Further, the mobile terminal 100 receives an optimal parking slot conforming to the request from the server device 200 (\textcircled{2}). After the user selects the parking slot (\textcircled{3}), the mobile terminal 100 requests confirmation of the parking slot from the server device 200 (\textcircled{4}). The server device 200 transmits the results of confirmation, indicating whether the parking slot is available, to the user via the mobile terminal 100 (\textcircled{5}). In this case, the candidate group for the parking slots is recommended based on such considerations as routing distance, fuel efficiency, vehicle exit time, parking duration, etc.

In the case of the active auto-valet parking service according to the embodiment of the present invention, after the mobile terminal 100 has selected a parking slot, the server device 200 must check whether the selected parking slot is currently available because the selected parking slot may have already been occupied and parked in by another vehicle at the time point at which the parking slot is selected.

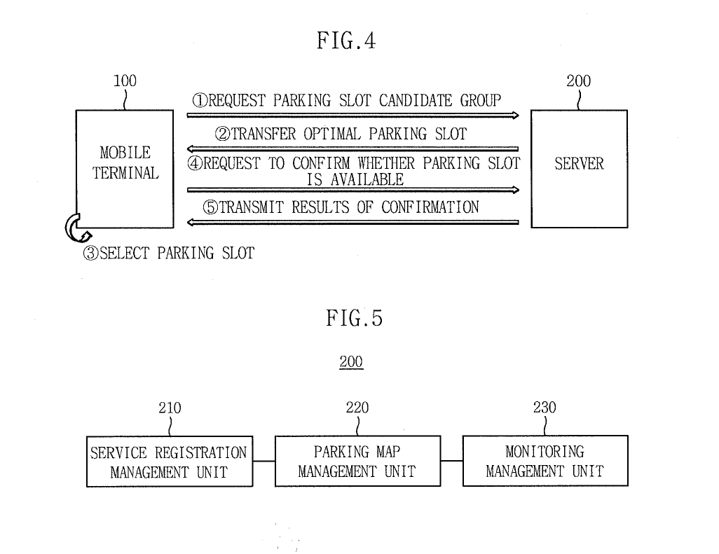

Meanwhile, the passive auto-valet parking service is configured such that the server device 200 receives auto-valet parking profile information inputted by the user via the mobile terminal 100, selects a final slot to be provided to the user, and provides the final slot to the user via the mobile terminal 100. This passive auto-valet parking service will be described in detail later with reference to FIGS. 5 to 15.

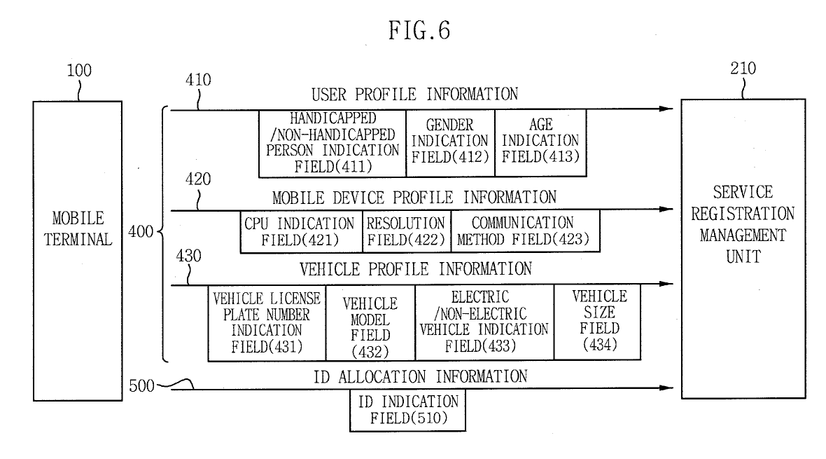

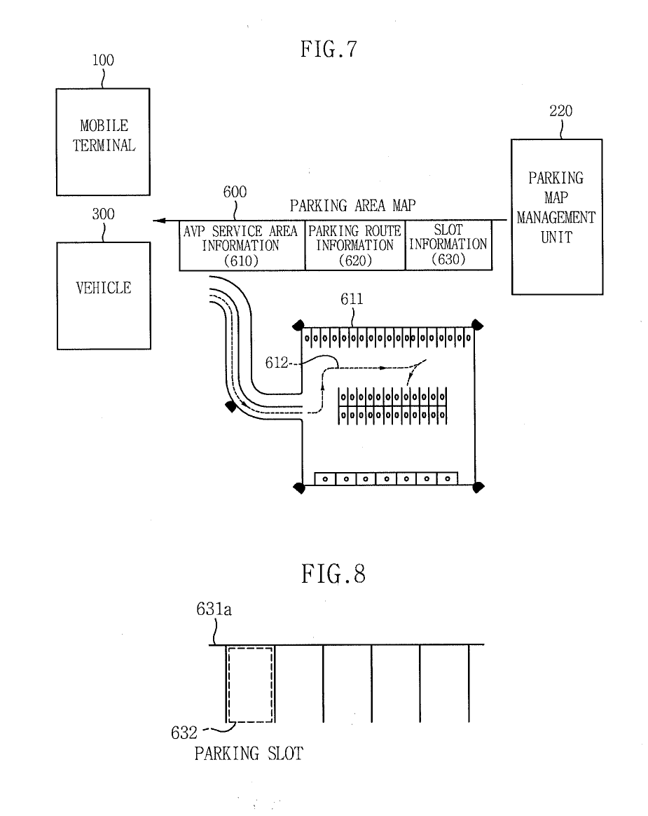

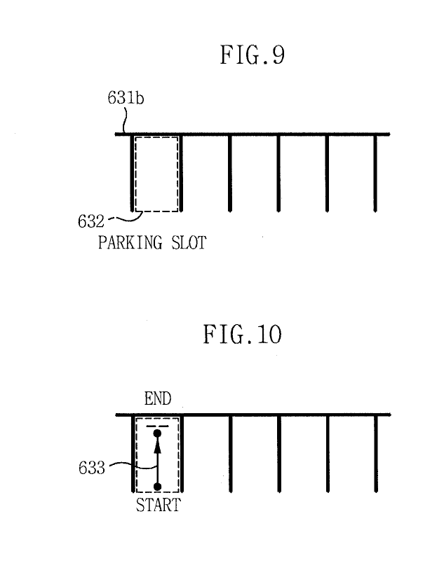

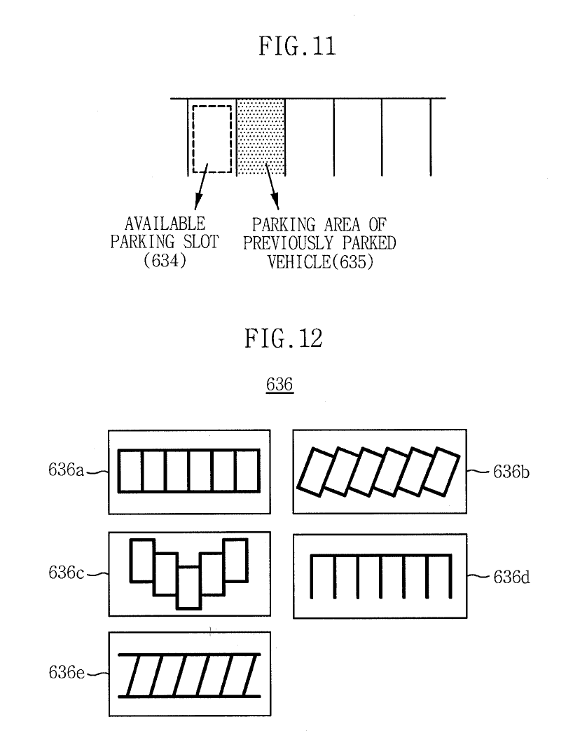

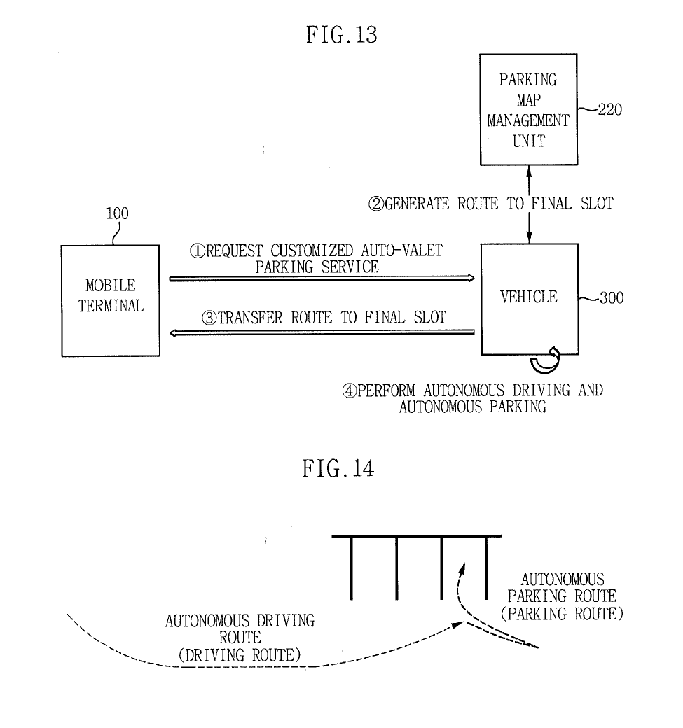

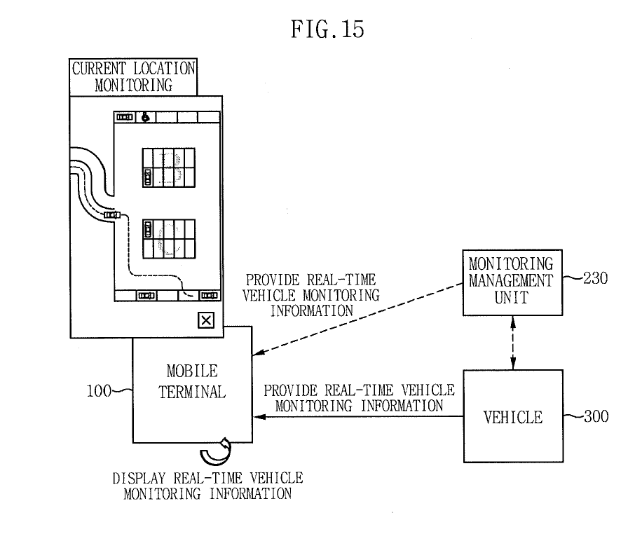

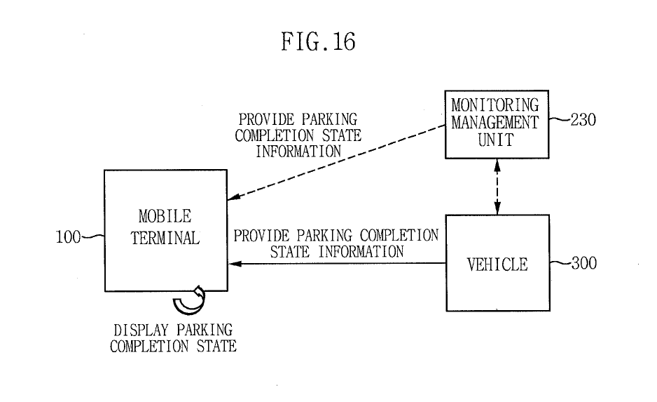

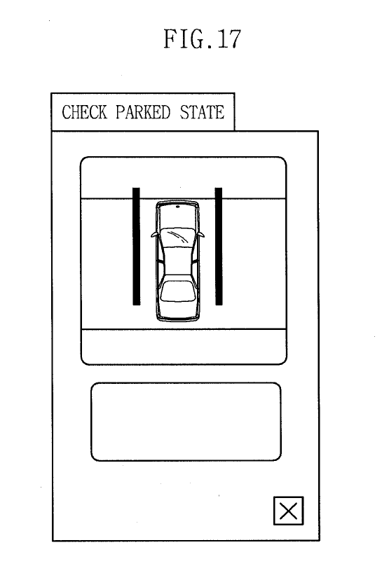

FIG. 5 is a diagram schematically showing the server device of FIG. 1. FIG. 6 is a diagram schematically showing auto-valet parking profile information according to an embodiment of the present invention. FIG. 7 is a diagram schematically showing a parking area map according to an embodiment of the present invention. FIGS. 8 to 12 are diagrams schematically showing the slot information of the parking area map shown in FIG. 5. FIG. 13 is a diagram showing an example in which a route to a final slot is generated according to an embodiment of the present invention. FIG. 14 is a diagram showing an example of a route to a final slot according to an embodiment of the present invention. FIG. 15 is a diagram showing an example in which real-time vehicle monitoring information is provided according to an embodiment of the present invention. FIG. 16 is a diagram showing an example in which parking completion state information is provided according to an embodiment of the present invention. FIGS. 17 and 18 are diagrams showing an example in which parked state information and an available parking slot are generated according to an embodiment of the present invention.

As shown in FIG. 5, the server device 200 according to an embodiment of the present invention includes a service registration management unit 210, a parking map management unit 220, and a monitoring management unit 230.

The service registration management unit 210 receives auto-valet parking profile information, transferred by a user who desires to register himself or herself on the customized auto-valet parking service, via the mobile terminal 100. Once the reception of the auto-valet parking profile information from the user has finished, the service registration management unit 210 transmits identification (ID) allocation information including ID to the mobile terminal 100 of the user, and then completes registration on the customized auto-valet parking service.

In detail, referring to FIG. 6, auto-valet parking profile information 400 includes user profile information 410, mobile profile information (mobile device profile) 420, and vehicle profile information 430.

The user profile information 410 is basic information required to select a customized parking slot suitable for the characteristics of the user. The user profile information 410 includes a handicapped/non-handicapped person indication field 411 for indicating whether a user is a handicapped person or not, a gender indication field 412 for indicating the gender of the user, and an age indication field 413 for indicating the age of the user. Although the description of the embodiment of the present invention has been such that the user profile information 410 includes indication of handicapped/non-handicapped persons, gender and age, the present invention is not limited to this embodiment and the user profile information 410 may include any user-related information required to generate customized parking slots.

The mobile device profile information 420 is basic information about a mobile terminal which receives a parking area map and determines whether a parked state can be monitored. The mobile device profile information 420 includes a CPU indication field 421 for indicating the Central Processing Unit (CPU) of the mobile terminal, a resolution field 422 for indicating resolution, and a communication method field 423 for indicating a network. In the embodiment of the present invention, the mobile device profile information 420 is described as including the CPU, resolution and network of the mobile terminal, but the present invention is not limited to this embodiment, and the mobile device profile information 420 may include all of the mobile terminal-related information required to provide the customized auto-valet parking service.

The vehicle profile information 430 is basic information required to select a customized parking slot in conformity with the characteristics of the vehicle. The vehicle profile information 430 includes a vehicle license plate number field 431 for indicating the license plate number of the vehicle, a vehicle model field 432 for indicating a vehicle model, an electric/non-electric vehicle indication field 433 for indicating whether the vehicle is an electric vehicle, and a vehicle size field 434 for indicating the size of the vehicle. In the embodiment of the present invention, the vehicle profile information 430 is described as including the vehicle license plate number, small/non-small vehicle indication (that is, the vehicle model), electric/non-electric vehicle indication, and vehicle size, but the present invention is not limited to this embodiment, and the vehicle profile information 430 may include all of the vehicle-related information required to generate customized parking slots.

The ID allocation information 500 is information required to transfer the allocated ID to the mobile terminal 100 after the reception of the auto-valet parking profile information has finished. The ID allocation information 500 includes an ID indication field 510 for indicating the ID.

Referring back to FIG. 5, the parking map management unit 220 provides the parking area map via the mobile terminal 100 to the user who has been registered on the customized auto-valet parking service. The parking area map according to an embodiment of the present invention includes pieces of information about customized parking slots that are generated using the auto-valet parking profile information 400. Here, the customized parking slots are optimal parking slots for the customized auto-valet parking service, which have been generated on the basis of considerations such as the auto-valet parking profile information 400 and parking space information, for example, department stores, apartments, restaurants, and business centers.

Further, the parking map management unit 220 provides the parking area map to the vehicle 300 so that the parking area map can be used as the basic information (back data) required for vehicle control. That is, the parking area map is provided to create a display so that the user can select and monitor a parking slot via the mobile terminal 100, and is used as the basic information required for vehicle control in the vehicle 300.

In detail, referring to FIG. 7, a parking area map 600 includes AVP service area information 610, parking route information 620, and slot information 630.

The AVP service area information 610 is information about a parking space 611 for which the customized auto-valet parking service is provided, wherein such a parking space is formed in the shape of a polygon.

The parking route information 620 is information about a route 621 to the parking space.

The slot information 630 includes information about all slots that constitute the parking space including customized parking slots that have been determined taking into consideration the auto-valet parking profile information 400.

In detail, as shown in FIGS. 8 to 12, the slot information 630 includes a slot outline 631a or 631b, a parking slot 632, a parking direction 633, an available parking slot 634, and a slot type 636.

The slot outline 631a or 631b is indicated in the form of a line or a polygon, and is a partition for discriminating between parking slots in the parking space.

The parking slot 632 denotes information for indicating each space in which a vehicle is actually parked.

The parking direction 633 denotes information for indicating a direction in which the vehicle enters when being parked.

The available parking slot 634 denotes information for indicating whether a slot area except for an invaded area is available for parking (in the form of a vehicle size or the like) when a vehicle (not shown), previously parked, in a neighboring parking area 635, invades a relevant parking slot.

The slot type 636 includes pieces of information about individual types of shapes 636a to 636e in which slots are formed. Here, the type-based slot information 636a is data required to indicate a slot formed to have a rectangular type of shape. The type-based slot information 636b is data required to indicate a slot formed to have a slanted rectangular type of shape. The type-based slot information 636c is data required to indicate a slot formed to have an uneven rectangular type of shape. The type-based slot information 636d is data required to indicate a slot formed to have an open rectangular type of shape. The type-based slot information 636e is data required to indicate a slot formed to have a diamond type of shape.

In the embodiment of the present invention, the slot information 630 may further include slot size data required to classify parking slots into small, medium and large parking slots depending on the size of vehicles, and handicapped parking slot information required to indicate slots for a handicapped parking area.

Further, the parking map management unit 220 generates a route to the final slot selected by the user from among customized parking slots, and then allows the autonomous driving and autonomous parking of the vehicle 300 to be initiated.

For example, referring to FIG. 13, when a parking area map is transferred to the mobile terminal 100, and the user selects a final slot from among customized parking slots and requests the customized auto-valet parking service from the vehicle 300 (\textcircled{1}), the parking map management unit 220 generates a route to the final slot (\textcircled{1}\textcircled{2}), and transfers the route to the mobile terminal 100, thus enabling the autonomous driving and autonomous parking of the vehicle 300 to be initiated (\textcircled{3}, \textcircled{4}). In the embodiment of the present invention, the parking map management unit 220 of the server device 200 is described as generating the route to the final slot, but the present invention is not limited to this embodiment, and even the vehicle 300 can generate the route to the final slot.

The route to the final slot according to the embodiment of the present invention includes an autonomous driving route and an autonomous parking route, as shown in FIG. 14. The route to the final slot is displayed on the screen of the mobile terminal 100 in the form of shape information such as a list of points (line string) and is then provided to the user. Here, the autonomous parking route includes routes for all parking methods, such as longitudinal parking, head-on parking, and reverse parking.

Referring back to FIGS. 5 and 15, the monitoring management unit 230 provides real-time vehicle monitoring information to the mobile terminal 100 so that the user can determine the position of the vehicle 300 in real time while autonomous driving and autonomous parking are being performed. Such provision of real-time vehicle monitoring information by the monitoring management unit 230 denotes the case where the detection of the position information of the vehicle (positioning), the angle information of the vehicle (vehicle heading angle), the parked state information of the vehicle (vehicle geometry), and an obstacle is performed by the server device 200 using infra sensors.

In detail, the monitoring management unit 230 provides the real-time vehicle monitoring information as a full screen image or a background at the request of the user. That is, when the real-time vehicle monitoring information is received as the background, the user can monitor in real time the progress of the customized auto-valet parking service on a GUI screen at any time and at the desired time while performing other tasks.

Meanwhile, the vehicle 300 also provides the real-time vehicle monitoring information to the mobile terminal 100 so that the position of the vehicle 300 can be determined in real time while autonomous driving and autonomous parking are being performed. Such provision of the real-time vehicle monitoring information by the vehicle 300 denotes the case where the independent driving of the vehicle 300 is performed, that is, the case where all sensors are mounted on the vehicle 300, and the detection of all of the position information of the vehicle 300 (positioning), the angle information of the vehicle (vehicle heading angle), the parked state information of the vehicle (vehicle geometry), and an obstacle is performed by the vehicle 300.

The real-time vehicle monitoring information transferred to the mobile terminal 100 according to an embodiment of the present invention includes information about the parking area map, a route to the location of a final slot, and the parked state of the vehicle.

The parking area map information is displayed as the background of the mobile terminal 100.

The information ab [symbol] ou

out the route to the location of the final slot is updated in real time and is transmitted to the mobile terminal 100 when an obstacle is avoided and a change in a route occurs, or when another vehicle has already been parked in the final slot selected by the user, or when parking using a planned parking method is impossible and then a parking method must be changed, for example, when a change from head-on parking to reverse parking occurs.

The vehicle parked state information includes vehicle position information, parked state information (vehicle geometry), vehicle angle information (vehicle heading angle, for example, an angle with respect to a due north direction), and vehicle state information. Here, the vehicle state information includes temporary stop state information and restart (go) state information which are caused by a moving obstacle during autonomous driving, avoidance state information caused by a fixed obstacle, stop information for autonomous parking, gear shift information (for example, a shift from forward gear to reverse gear, etc.), and information indicating whether the vehicle is currently being autonomously parked or the autonomous parking of the vehicle has been completed.

Further, as shown in FIG. 16, the monitoring management unit 230 transfers parking completion state information to the mobile terminal 100 if the parking of the vehicle 300 has been completed. That is, the monitoring management unit 230 provides the parking completion state information using image sensors installed on the infra.

Meanwhile, the vehicle 300 also transfers parking completion state information to the mobile terminal 100 if the parking of the vehicle 300 has been completed. That is, the vehicle 300 generates parking completion state information using image cameras mounted thereon, as shown in FIG. 17, extracts parked state information (vehicle geometry information) from the generated information, and transmits the extracted parked state information. In this case, as shown in FIG. 18, the parking map management unit 220 calculates information about an available parking slot around a relevant parking slot on the basis of the parked state information that has been extracted from the parking completion state information, and stores the information about the available parking slot.

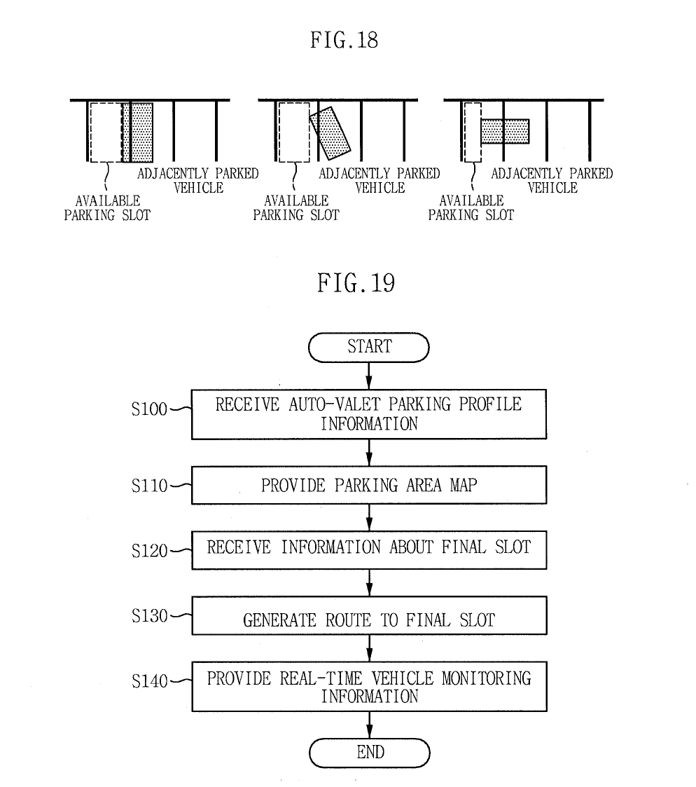

FIG. 19 is a flowchart showing the flow of a process in which the server device of FIG. 5 provides a customized auto-valet parking service.

As shown in FIG. 19, the service registration management unit 210 of the server device 200 according to an embodiment of the present invention receives auto-valet parking profile information from a user who requests registration on the customized auto-valet parking service, and, if the reception has been completed, transfers ID allocation information to the mobile terminal 100, and then completes registration on the customized auto-valet parking service at step S100.

The parking map management unit 220 provides a parking area map, including information about customized parking slots, via the mobile terminal 100 when the registered user requests the customized auto-valet parking service at step S110. The parking map management unit 220 receives information about a final slot, selected by the user from among the customized parking slots of the parking area map, via the mobile terminal 100 at step S120. Further, the parking map management unit 220 generates a route to the final slot using the final slot information, and then allows the autonomous driving and autonomous parking of the vehicle 300 to be initiated at step S130.

The monitoring management unit 230 performs monitoring while the vehicle 300 is performing autonomous driving and autonomous parking along the route to the final slot, thus providing real-time vehicle monitoring information to the mobile terminal 100 at step S140.

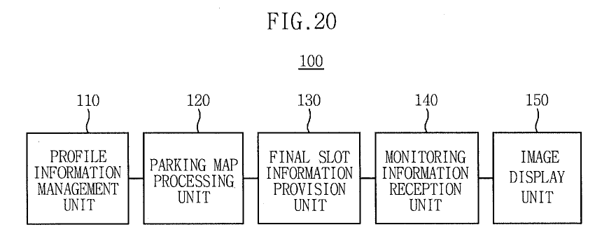

FIG. 20 is a diagram schematically showing the mobile terminal of FIG. 1.

As shown in FIG. 20, the mobile terminal 100 according to an embodiment of the present invention includes a profile information management unit 110, a parking map processing unit 120, a final slot information provision unit 130, a monitoring information reception unit 140, and an image display unit 150.

The profile information management unit 110 receives the auto-valet parking profile information 400 from a user and stores the auto-valet parking profile information 400 (refer to FIG. 6). Further, the profile information management unit 110 transfers the auto-valet parking profile information 400 to the server device 200 so as to be provided with the customized auto-valet parking service.

The parking map processing unit 120 receives a parking area map 600 from the server device 200 when the user is registered on the customized auto-valet parking service (refer to FIG. 7). The parking map processing unit 120 displays the parking area map 600 on the image display unit 150, thus allowing the user to select a final slot from among customized parking slots. That is, the parking map processing unit 120 displays a parking space, in which the vehicle 300 is to be parked, using the AVP service area information 610 of the parking area map 600, displays the customized parking slots using slot information 630 to allow the user to select the final slot, and displays a route to the location of the final slot selected by the user on the image display unit 150.

The final slot information provision unit 130 transmits information about a determined final slot to the server device 200 once the user has selected the final slot from among the customized parking slots using the parking area map 600 displayed on the image display unit 150. Further, the final slot information provision unit 130 receives information about the route to the final slot from the server device 200. The final slot information provision unit 130 requests the vehicle 300 to perform autonomous driving and autonomous parking along the route to the final slot.

The monitoring information reception unit 140 receives real-time vehicle monitoring information from the server device 200 and provides the received information to the user via the image display unit 150 while the autonomous driving and autonomous parking of the vehicle 300 are being performed along the route to the final slot. Further, the monitoring information reception unit 140 receives parking completion state information from the server device 200 or the vehicle 300 once the parking of the vehicle 300 has been completed.

The image display unit 150 displays all images, needed for being provided with the customized auto-valet parking service, on the mobile terminal 100.

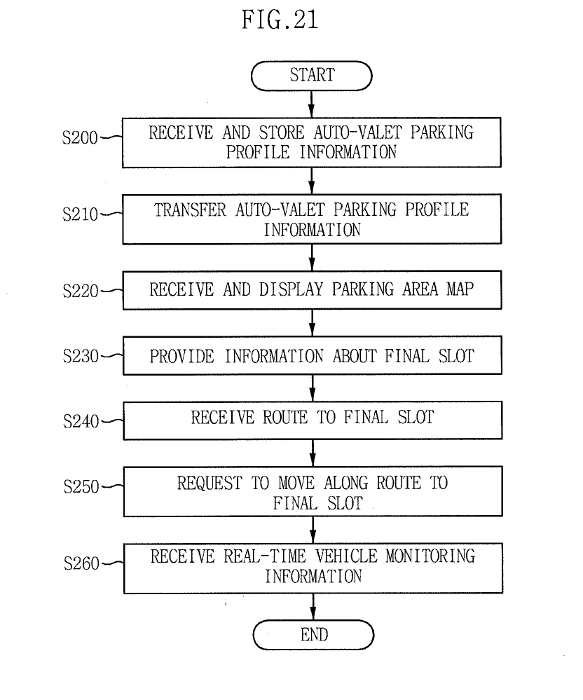

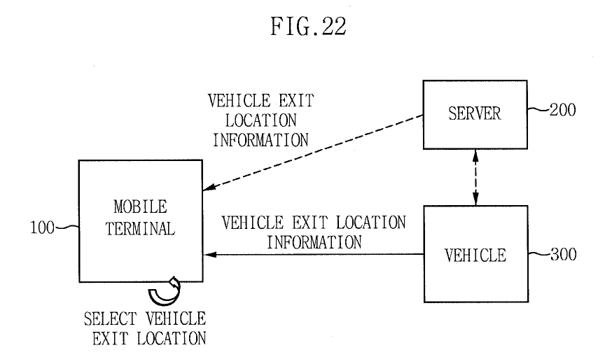

FIG. 21 is a flowchart showing the flow of a process in which the mobile terminal of FIG. 20 provides a customized auto-valet parking service. FIG. 22 is a diagram showing an example of the autonomous exit of a vehicle according to an embodiment of the present invention.

As shown in FIG. 21, the profile information management unit 110 of the mobile terminal 100 according to an embodiment of the present invention receives auto-valet parking profile information 400 from the user and stores the received information at step S200. The profile information management unit 110 transfers the stored auto-valet parking profile information 400 to the server device 200 and then requests registration on the customized auto-valet parking service from the server device 200 so that the customized auto-valet parking service can be provided at step S210.

After the registration has been completed, the parking map processing unit 120 receives a parking area map 600 from the server device 200. The parking map processing unit 120 displays the parking area map 600 on the image display unit 150 so that the user can select a final slot from among the customized parking slots at step S220.

The final slot information provision unit 130 provides information about a selected final slot to the server device 200 once the user has selected the final slot from among the customized parking slots using the parking area map 600 at step S230. Further, the final slot information provision unit 130 receives information about a route to the final slot from the server device 200 using the information about the final slot at step S240. The final slot information provision unit 130 requests the vehicle 300 to move along the route to the final slot at step S250.

The monitoring information reception unit 140 receives real-time vehicle monitoring information from the server device 200 and provides it to the user via the image display unit 150 while the vehicle 300 is performing autonomous driving and autonomous parking along the route to the final slot at step S260.

Although the embodiments of the present invention have mainly described the customized auto-valet parking service as offering autonomous parking, the autonomous exit of the vehicle can also be provided to the user in the same manner as autonomous parking, as shown in FIG. 22. However, the final exit location of the vehicle is selected in such a way that the mobile terminal 100 selects a location indicated on a parking area map and transmits information about the selected location both to the server device 200 and to the vehicle 300.

As described above, the user-customized auto-valet parking system according to the embodiments of the present invention can more conveniently provide an auto-valet parking service in consideration of the conditions of a user by providing parking slots in a user-customized manner because customized parking slots are provided in consideration of user profile information, mobile device profile information, and vehicle profile information, unlike a conventional scheme for searching for and providing only the locations of empty slots.

Further, in the embodiments of the present invention, the user personally selects a desired final slot from among customized parking slots via a mobile terminal, receives a screen on which a route to the selected final slot is displayed, and monitors the screen in real time, thus allowing the user to be provided with the auto-valet parking service in real time without having to install a separate device on a vehicle.

As described above, optimal embodiments have been described in the drawings and the present specification. Although specific terms have been used here, these are merely intended to describe the present invention and are not intended to limit the meanings of terms and the scope of the present invention described in the accompanying drawings. Therefore, those skilled in the art will appreciate that various modifications and other equivalent embodiments are possible from the above optimal embodiments. Therefore, the technical scope of the present invention should be defined by the technical spirit of the accompanying claims.

What is claimed is:

1. A server device, comprising:
a service registration management unit for receiving Auto-Valet Parking (AVP) profile information that includes information about one or more of a user, a vehicle, and a mobile terminal; and
a parking map management unit for generating customized parking slots suitable for the user using the auto-valet parking profile information, and providing a parking area map, which includes information about the customized parking slots, to the mobile terminal,
wherein the parking map management unit receives information about a final slot selected by the user from among the customized parking slots via the mobile terminal, and provides a route to the final slot.

2. The server device of claim 1, wherein the auto-valet parking profile information comprises:
user profile information including information related to the user;
mobile device profile information including information related to the mobile terminal; and
vehicle profile information including information related to the vehicle.

3. The server device of claim 2, wherein the user profile information comprises a handicapped/non-handicapped person indication field for indicating whether the user is a handicapped person, a gender indication field for indicating a gender of the user, and an age indication field for indicating an age of the user.

4. The server device of claim 2, wherein the mobile device profile information comprises a Central Processing Unit (CPU) indication field for indicating a CPU of the mobile terminal, a resolution field for indicting resolution, and a communication method field for indicating a network.

5. The server device of claim 2, wherein the vehicle profile information comprises a vehicle license plate number field for indicating information about the vehicle, a vehicle model field for indicating a vehicle model, an electric/non-electric vehicle indication field for indicating whether the vehicle is an electric vehicle, and a vehicle size field for indicating a size of the vehicle.

6. The server device of claim 2, wherein the parking area map comprises:
AVP service area information including information about a parking space;
parking route information including a route to the parking space; and
slot information including information about all slots in the parking space.

7. The server device of claim 6, wherein the slot information comprises:
a slot outline indicated in a form of a line or a polygon defining the parking space;
a parking slot for indicating information about each space in which a vehicle can be actually parked;
a parking direction for indicating a direction in which the vehicle of the user enters when being parked;
an available parking slot for indicating a possibility that the vehicle can be parked in an area except for an area invaded by a vehicle parked in a parking slot that is adjacent to the parking slot; and
a slot type for indicting information about individual types of shapes in which the parking slots are formed.

8. The server device of claim 7, wherein the parking map management unit calculates an available parking slot among slots adjacent to the final slot based on image information captured by a camera installed in the vehicle once parking of the vehicle of the user in the final slot has been completed.

9. The server device of claim 1, further comprising a monitoring management unit for performing monitoring while the vehicle of the user is performing autonomous driving and autonomous parking along the route to the final slot, then providing real-time vehicle monitoring information.

10. A mobile terminal, comprising:
a profile information management unit for transferring Auto-Valet Parking (AVP) profile information, which includes information about one or more of a user, a vehicle, and a mobile terminal, to a server device and requesting registration of a customized auto-valet parking service;
a parking map processing unit for performing control such that it receives a parking area map, which includes information about customized parking slots suitable for the user, from the server device and displays the parking area map; and
a final slot information provision unit for transferring information about a final slot to the server device if the user determines the final slot from among the customized parking slots,
wherein the final slot information provision unit receives information about a route to the final slot, generated by the server device using the information about the final slot, and requests the vehicle of the user to move along the route to the final slot and to be autonomously parked in the final slot.

11. The mobile terminal of claim 10, further comprising a monitoring information reception unit for receiving from the server device, information about real-time vehicle monitoring performed while the vehicle is performing autonomous driving and autonomous parking along the route to the final slot.

12. The mobile terminal of claim 10, wherein the auto-valet parking profile information comprises:
user profile information including information related to the user;
mobile device profile information including information related to the mobile terminal; and
vehicle profile information including information related to the vehicle.

13. The mobile terminal of claim 10, wherein the parking area map comprises:
AVP service area information including information about a parking space;
parking route information including a route to the parking space; and
slot information including information about all slots in the parking space.

14. A method of providing a customized auto-valet parking service, comprising:
receiving auto-valet parking profile information, which includes information about one or more of a user, a vehicle, and a mobile terminal, via the mobile terminal of the user;
transferring a parking area map, which includes customized parking slots that are generated using the auto-valet parking profile information and are suitable for the user, to the mobile terminal;
receiving information about a final slot, determined by the user from among the customized parking slots, from the mobile terminal; and
generating a route to the final slot so that the vehicle can be autonomously parked, and transferring the route to the mobile terminal.

15. The method of claim 14, further comprising:
once parking of the vehicle in the final slot has been completed, capturing image information about neighboring slots adjacent to the final slot using a camera installed in the vehicle; and
generating information about an available parking slot among the neighboring slots, based on the image information.

16. The method of claim 14, further comprising transferring identification allocation information including identification to the mobile terminal if the user is registered on the customized auto-valet parking service.
